(19) United States
(12) Patent Application Publication
(10) Pub. No.: US 2026/0285647 A1
(43) Pub. Date: Sep. 24, 2026

(54) METHOD OF LIFTING A WIND TURBINE BLADE

(71) Applicant: Liftra IP ApS, Aalborg SV (DK)

(72) Inventors: Per Eske FENGER, Terndrup (DK); Alexander Becsei CHRISTIANSEN, Hjørring (DK); Ruben Tjell LAMBERTSEN, Gandrup (DK)

(73) Assignee: Liftra IP ApS, Aalborg SV (DK)

(21) Appl. No.: 19/472,055

(22) PCT Filed: Apr. 3, 2024
(86) PCT No.: PCT/EP2024/059015

§ 371 Date: Oct. 2, 2025

(30) Foreign Application Priority Data
Apr. 3, 2023 (DK) PA202370166

(51) Int. Cl. B66C 1/10; F03D 13/10

(52) U.S. Cl. CPC B66C 1/108; F03D 13/10

(57) ABSTRACT

Method of lifting a wind turbine blade, where said method comprises the step of providing a wind turbine blade, providing a blade yoke and connecting the blade yoke to the blade, providing an elongated element connected to the blade adjacent to the suction or pressure surface, the elongated element: being arranged along at least 50% of the outer ⅓ of the blade, being arranged along the longitudinal axis of the blade, and the elongated element being arranged to reduce the coefficient of lift of the blade by more than 20%, and lifting the blade via the blade yoke. In this way, a simple way of mitigating the lift of the blade during lifting operations can be provided which increases the safety of the procedure and allows smaller lifting yokes to be used in the same winds, or the same lifting yokes to be used in higher winds.

The current invention relates to a method of lifting a wind turbine blade.

### DESCRIPTION OF RELATED ART

When erecting wind turbines, it is typical that the wind turbine tower is erected first, after which the nacelle is placed on top of the tower. Then a rotor hub is mounted on the drive shaft of the turbine after which the wind turbine blades are individually attached to the hub. During the step of attaching the blades to the hub, the blades need to be lifted from the ground with a crane. During the lifting operation, tag line systems are often used to hold the blade in a certain position. However, the wind will affect the position and motion of the blade. When the wind speed increases, the loads on the blade increase and at a certain wind speed, it becomes difficult to maintain the blade in a stable position in a safe manner.

In addition, the wind acting on the blade can result in undesired motion of the blade. In certain cases, the tip of the blade can be lifted up or pushed down due to the wind. The motion will be dependent on the wind direction and the orientation of the blade. Since the blade is typically hanging from a crane lifting wire in a horizontal position, once the wind force is removed, the blade tip will drop or lift again respectively in order to restore the stable horizontal position of the blade. However, this will start a pendulum motion which is hard to stop. This is very undesired as it is dangerous for the operators, the crane as well as the blade and the other components of the wind turbine.

Furthermore, once the blade has been lifted to the rotor hub, then it needs to be attached to the rotor hub via a series of bolts. During the bolting operation, it is necessary to keep the blade very still and in a constant position. Again, any wind loads on the blade will cause motion of the blade and it is therefore necessary to hold the blade via taglines or other form of position control systems. Again, when the wind speeds go over a certain level, then the operation needs to be stopped as too many forces are required to hold the blade in place.

The expected maximum wind loads on the blade will also be used to calculate the size and strength of the blade yoke which is needed to lift the blade. It is to be noted that the blade is held in place in the blade yoke via friction pads which press against the surface of the blade. In order to hold the blade securely, the friction needs to be greater than the largest expected forces which try to move the blade in the blade yoke. The friction is increased by increasing the normal loads of the friction pad (ie the clamping forces) against the surface of the blade. However, there is an upper limit on the clamping forces, as clamping forces over a certain amount can cause damage to the blade and/or the blade yoke. Hence, the limit on the acceptable clamping forces will establish a limit on the maximum allowable wind speed and/or the maximum expected wind speed will determine the clamping forces and/or the design and strength of the blade yoke needed. If higher winds are expected, larger and stronger blade yokes are required. The procedure for sizing an appropriate blade yoke is known in the art and will not be described in detail here.

For the sake of good order, it should be noted that there have been proposals in the art, see CN113685311A and CN114687960A which propose mitigating oscillations of a blade caused by vortex shedding by arranging diagonal elements on the blade while the blade is mounted on the wind turbine. At first glance, these solutions appear similar to the current invention, however, they are only relevant when using hindsight. These prior art proposed solutions have not been implemented in practice as they are not really relevant in the real world. The vortex shedding effects caused by wind loads only act on bluff bodies, such as wind turbine towers. However, a blade with its aerodynamic shape will not really see vortex shedding induced oscillations due to wind acting along the chord direction of the blade (as will be the case during lifting operations). A blade will possibly see vortex shedding induced oscillations due to wind loads acting perpendicular to the chord of the blade. However this will not really be relevant during lifting operations, since winds are typically horizontal and the blade is typically lifted such that the chord is arranged in a horizontal orientation. Hence vortex shedding oscillations on a blade are essentially non-existent during lifting operations. Even when mounted on the hub, vortex induced oscillations on blades are not very common since the blades can be adjusted in pitch and the hub rotated to put the blades in a position where they experience low vortex shedding. Hence, the solutions proposed in the art have not been implemented in practice as they are not relevant in real life. It seems that the prior art proposed solutions are a simple adaptation of the methods used for reducing oscillations on turbine towers to blades, even though they are not relevant in practice.

Furthermore it should be noted that the anti-vortex shedding solutions proposed by the cited patents propose similar structures as those used on a wind turbine tower. These are large elements which, while reducing the potential for vortex shedding oscillations, will also increase the drag of the blade. This will increase the torque on the blade about the lifting wire during a lifting operation. Hence, while the vortex shedding effects are almost insignificant during lifting of a blade, the drag of the cited solutions is increased which is undesired. Hence, there is no incentive for the person skilled in the art to use the prior art cited solutions in an actual lifting operation.

### SUMMARY OF THE INVENTION

A first aspect of the current invention is to provide a method of lifting a wind turbine blade where the position of the blade is more stable during the lifting operation than in the prior art.

A second aspect of the current invention is to provide a method of lifting a wind turbine blade where the effects of wind on the blade are reduced during the lifting operation.

A third aspect of the current invention is to provide a method of lifting a wind turbine blade where a particular blade and blade yoke combination can be used in higher wind speeds than the prior art methods.

These aspects are provided at least in part by a method according to claim 1. In this way, a simple and effective way of mitigating the lift of the blade is provided. This allows blade yokes to be used at higher maximum wind speeds and/or allows the size of blade yokes to be reduced for a certain expected maximum wind speed and/or allows the clamping forces on the blade to be reduced for a certain expected maximum wind speed.

It should be noted that the order of the steps in the method claims should not be limited to the specific order presented in the claims, but should allow the steps to be performed in any logical order. For example, in the method claim 1, the step of providing and attaching a blade yoke to the blade is listed before the step of providing an elongated member connected to the blade. However, the scope of protection should also include the method where an elongated member is attached to the blade before the blade yoke is attached to the blade.

It should also be noted that the term “outer” refers to the distance from the root of the blade. For example, the outer ⅓^{rd} of the blade should be understood as the portion of the blade the tip of the blade to a position located ⅓^{rd} of the length of the blade away from the tip towards the root of the blade.

In some embodiments, the elongated element has a height which is greater than 0.1%, greater than 0.2% or greater than 0.3% of the local chord of the blade. In some embodiments, the elongated element has a height which his less than 10%, less than 7% or less than 5% of the local chord of the blade.

In some embodiments, the elongated element is arranged along 50% of the outer half of the blade. In some embodiments, the elongated element is arranged along 75% of the outer half of the blade.

In some embodiments, the dimension of the elongated element parallel to the chord of the blade is less than 50%, less than 40% or less than 30% of the local chord length. It should be noted that when comparing the elongated element with the chord, the comparison should compare the dimensions of the elongated element and the chord at the same radial location along the blade. In other words, the dimension of the elongated element parallel to the chord of the blade at a distance of 50% of the length of the blade from the base of the blade should be compared to the chord length at a distance of 50% of the length of the blade from the base of the blade.

In some embodiments, the elongated element reduces the coefficient of lift by more than 30%, more than 40% or more than 50%. In some embodiments, the elongated element increases the coefficient of drag of the blade by less than 50%, less than 40%, less than 30% or less than 20%.

In some embodiments, the elongated element is arranged such that the distance parallel to the local chord between the centre line of the elongated element and the leading edge of the blade is less than 50%, less than 40% or less than 30% of the local chord length of the blade.

In some embodiments, the elongated element is attached to the suction or the pressure surface of the blade. In some embodiments, the elongated element is attached to the blade via an adhesive. In some embodiments, the elongated element is attached to the blade via individual brackets attached to the blade and spaced apart from each other along the length of the elongated element. In some embodiments, the elongated element is not attached to the suction or pressure surface of the wind turbine blade directly, but only connected to the wind turbine blade via an attachment to the blade yoke and an attachment member attached to the wind turbine blade.

In some embodiments, the method further comprises the steps of: calculating the maximum estimated lift generated by the blade with the elongated member connected to the blade due to the maximum expected wind speed and sizing the blade yoke according to the maximum estimated lift generated by the blade with the elongated member connected to the blade.

In some embodiments, the method further comprises the steps of attaching one end of the elongated element to the blade yoke, providing an attachment member, attaching the attachment member to the blade at a location near the tip of the blade and attaching another end of the elongated element to the attachment member.

In some embodiments, the elongated element is arranged such that the local distance perpendicular to the local chord between the edge of the elongated element facing away from the surface of the blade which the elongated element is arranged closest to and said surface, is less than 10%, less than 7.5% or less than 5% of the local chord length.

In some embodiments, the attachment member is located in the outer fifth, outer sixth or outer seventh of the blade.

In some embodiments, the steps of providing an attachment member and attaching the attachment member to the blade, comprises providing a blade tip clamp and said step of attaching the attachment member to the blade at a location near the tip of the blade comprises attaching the blade tip yoke to the blade near the tip of the blade.

In some embodiments,
a. said step of providing an attachment member includes providing a blade tip clamp,
b. said step of attaching another end of the elongated member to the attachment member comprises attaching the other end of the elongated member to the blade tip clamp,
c. said method further comprises the steps of:
   i. rotating the rotor hub until the blade to which the blade tip clamp is to be attached is in a downwardly extending orientation,
   ii. lowering the blade tip clamp along the blade from the blade yoke via the elongated member, and
   iii. controlling the position of the blade tip clamp relative to the blade via taglines attached to the blade tip clamp, and
d. said step of attaching the attachment member to the blade at a location near the tip of the blade comprises attaching the blade tip yoke to the blade near the tip of the blade.

In some embodiments, the step of providing an attachment member includes providing a blade tip clamp having one or more controllable lift generating devices,
a. said step of attaching another end of the elongated member to the attachment member includes attaching the other end of the elongated member to the blade tip clamp,
b. said method further comprises the step of flying the blade tip clamp via the one or more controllable lift generating devices to a position on the blade located remotely from the blade yoke, and
c. said step of attaching the attachment member to the blade at a location near the tip of the blade comprises attaching the blade tip yoke to the blade at a location near the tip of the blade.

It should be noted that the phrase “one or more controllable lift generating devices” should be understood as one or more devices which can provide lift in a controllable manner, such that the blade tip clamp can fly and lift its own weight in a controlled manner. One example of “one or more controllable lift generating devices” is an arrangement of four pitch controllable propellers arranged in a square formation, as is well known from the art of drones. In some embodiments, one could consider a blade tip clamp coupled to a drone.

This specification also relates to the use of an elongated member connected to a wind turbine blade and arranged along a longitudinal axis of the wind turbine blade to reduce the maximum generated lift of the wind turbine blade due to wind when lifting the wind turbine blade. In this way, the strength and/or size of the required blade yoke can be reduced when compared to lifting the same blade but without the elongated member in a certain expected wind range. Or the maximum allowable wind force for a blade, blade yoke and elongated member combination is increased when compared to the same blade and blade yoke combination but without the elongated member. Of course, both options can be combined to both reduce the size of the blade yoke required as well as increasing the allowable wind speed.

The elongated member in the use claim, could be further characterized according to any feature or combination of features described in this description pertaining to the elongated member.

This specification also relates to a device and/or a system for reducing motion and/or forces generated by a wind turbine blade due to winds when lifting the blade and/or reducing the effects of the wind on a blade when lifting the blade. In particular the specification relates to a wind turbine blade comprising such a device or system.

In some embodiments, a wind turbine blade having a longitudinal axis, a suction surface and a pressure surface is provided where the wind turbine blade further comprises an elongated element, said elongated element being connected to the blade and arranged adjacent to the suction or the pressure surface of the blade, being arranged along at least 50% of the outer ⅓^{rd} of the blade, extending along the longitudinal axis of the blade, and being arranged to reduce the coefficient of lift of the blade by more than 20%, more than 30%, more than 40% or more than 50%.

It should be noted that the phrase “extending along at least 50% of the outer ⅓^{rd} of the blade suggests that the elongated member does not necessarily have to be a continuous member, but could be arranged in multiple independent segments. In some embodiments, the elongated element extends along more than 75% of the outer ⅓^{rd} of the blade. In some embodiments, the elongated element extends along more than 50% of the outer half of the blade.

In some embodiments, the elongated element has a height, which is greater than 0.1%, greater than 0.2% or greater than 0.3% of the local chord length of the blade. In some embodiments, the elongated element has a height which is less than 10%, less than 7.5% or less than 5% of the local chord length of the blade.

In some embodiments, the elongated element is arranged along at least 50% of the outer half of the blade. In some embodiments, the elongated element is arranged along at least 75% of the outer half of the blade. In some embodiments, the dimension parallel to the chord of the blade is less than 50%, less than 40%, less than 30% or less than 20% of the local chord length.

In some embodiments, the elongated element is arranged such that the distance between the local centre of the elongated element and the leading edge of the blade is less than 50%, less than 40% or less than 30% of the local chord length of the blade.

In some embodiments, the elongated element is attached to the pressure or the suction surface of the blade via an adhesive. In some embodiments, the elongated element is not attached to the pressure or the suction surface of the blade via an adhesive.

In some embodiments, a wind turbine blade lifting system is provided comprising a wind turbine blade as described above and where the system further comprises a blade yoke attached to the blade near the centre of gravity of the blade, a blade tip clamp attached to the blade near the tip of the blade and in that the elongated element is arranged between the blade yoke and the blade tip clamp.

The current specification also discloses a second independent invention which could form the basis of a divisional application. The second independent invention is related to attaching a blade tip clamp to a wind turbine blade. In the figures described in more detail below, the second invention is used to attach an elongated element to the blade to act as a lift mitigation element. However, the method described in the description could also be used in other applications, where the main purpose is not having a lift mitigation effect, but just attaching a blade tip clamp to a blade. The second invention is described in more detail with reference to Examples 1 to 3 provided below.

Ex. 1. Method of attaching a blade tip clamp to a wind turbine blade, said method comprising the steps of:
a) rotating the rotor hub until the blade to which the blade tip clamp is to be attached is in a downwardly extending orientation,
b) lowering a blade tip clamp along the blade via an elongated element connected to the blade tip clamp, and
c) attaching the blade tip yoke to the blade.

Ex. 2. Method according to Ex. 1, characterized in that the method further comprises the step of attaching a blade yoke to the blade and in that the step of lowering the blade tip clamp along the blade includes lowering the blade tip clamp from the blade yoke.

Ex. 3. Method according to Ex. 1 or Ex. 2, characterized in that the method further comprises the step of controlling the position of the blade tip clamp relative to the blade via taglines.

The current specification also discloses a third independent invention which could form the basis of a divisional application. In many cases, it is desired to attach a tag line or other accessory to a blade tip via a blade tip clamp. Blade tip clamps are known in the art and are typically attached while the blade is on the ground. If the blade is already mounted on the wind turbine, then a crane needs to lift the blade tip clamp up to a blade where it is manually attached to the blade tip. This is a complicated operation. Furthermore, it is expensive to arrange a crane which is high enough to attach a prior art type blade tip clamp to a blade mounted on a wind turbine. Likewise, removing the prior art type blade tip clamps once the blade is installed on the turbine, is complicated and time consuming.

It is therefore a first aspect of the third invention to provide a blade tip clamp which is easier to attach to a blade which is already installed on a wind turbine.

A second aspect of the third invention is to provide a blade tip clamp which is easier to remove from the blade while the blade is installed on the wind turbine.

These aspects are provided according to the third invention by a blade tip claim unit as described below via the following examples 10 to 13 of the third invention.

Ex. 10. A blade tip clamp arranged to be attached to a wind turbine blade, the blade tip clamp comprising a clamp mechanism suitable for attaching the blade tip clamp to a blade near the tip of the blade, said clamp mechanism having a first configuration where the clamp mechanism is expanded and the blade tip clamp is not attached to a blade when arranged on the blade and a second configuration where the clamp mechanism is retracted and the blade tip clamp is attached to a blade when arranged on the blade; characterized in that said blade tip clamp further comprises at least one controllable lift generating device suitable for lifting the blade tip clamp from the ground to a blade in a controlled manner.

Ex. 11. A blade tip clamp according to example 10, characterized in that the blade tip clamp further comprises an attachment element for attaching one or more tag lines and/or one or more other accessories to the blade tip clamp.

Ex. 12. Method of attaching a blade tip clamp to a wind turbine blade, said method comprising the steps of:
a) providing a blade tip clamp having at least one controllable lift generating device,
b) flying the blade tip clamp to a position near the tip of the wind turbine blade via the at least one controllable lift generating device, and
c) attaching the blade tip clamp to the blade.

Ex. 13. Method according to example 12, characterized in that the method further comprises the steps of:
a. attaching a blade yoke to the blade, and
b. attaching a first end of an elongated element to the blade yoke, and a second end of the elongated element to the blade tip clamp prior to the step of flying the blade tip clamp to a position near the tip of the wind turbine blade.

It should be emphasized that the term “comprises/comprising/comprised of” when used in this specification is taken to specify the presence of stated features, integers, steps or components but does not preclude the presence or addition of one or more other features, integers, steps, components or groups thereof.

### BRIEF DESCRIPTION OF THE DRAWINGS

In the following, the invention will be described in greater detail with reference to embodiments shown by the enclosed figures. It should be emphasized that the embodiments shown are used for example purposes only and should not be used to limit the scope of the invention.

FIG. 1 shows a schematic cross section view through a wind turbine blade with a lift mitigating elongated element according to the current invention attached to the blade.

FIG. 2 shows a detailed cross section view according to the area defined by the circle marked with Il in FIG. 1.

FIG. 3 shows a schematic cross section view through a wind turbine blade with a second embodiment of a lift mitigating elongated element according to the current invention attached to the blade.

FIG. 4 shows the results of a computational fluid dynamic (CFD) analysis of a typical wind turbine blade airfoil.

FIG. 5 shows the results of a CFD analysis of the wind turbine blade of FIG. 4, but with a lift mitigating elongated element as shown in FIG. 1 attached on the suction surface of the blade near the leading edge of the blade.

FIG. 6 shows the results of a CFD analysis of the wind turbine blade of FIG. 4, but with a lift mitigating elongated element as shown in FIG. 3 arranged on the suction surface of the blade near the leading edge of the blade.

FIGS. 7 and 8 schematically show a top and front view respectively of a wind turbine blade being lifted with a blade yoke showing an alternative embodiment of a lift mitigating elongated element according to the current invention.

FIGS. 9 and 10 schematically show an embodiment of a method of applying a lift mitigating elongated element to a wind turbine blade in two different stages of the method.

FIGS. 11 and 12 schematically show another embodiment of a method of applying a lift mitigating elongated element to a wind turbine blade in two different stages of the method. FIGS. 11 and 12 also illustrate the second invention, where a method is provided to attach a blade tip clamp to a blade. FIG. 13 schematically shows another embodiment of a method of applying a lift mitigating elongated element to a wind turbine blade in one stage of the method.

FIG. 14 schematically shows a side view of a first embodiment of a blade tip clamp attached to a blade with a lift mitigating elongated element for providing blade lift mitigation.

FIG. 15 schematically shows a side view of an example of a blade tip clamp according to the third invention attached to a blade.

### DETAILED DESCRIPTION OF THE EMBODIMENTS

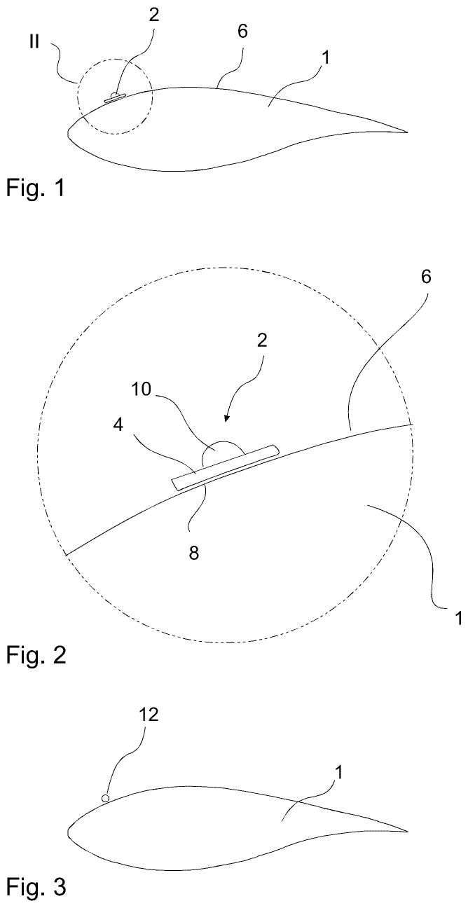

FIGS. 1 and 2 schematically show a cross section through a wind turbine blade 1 and an elongated lift mitigating element 2 according to the current invention. In this embodiment, the elongated lift mitigating element is an elongated element having a cross section with a base portion 4 which is arranged to be attached to the suction surface 6 of the wind turbine blade via an adhesive 8 and an upwardly protruding protrusion 10. In this embodiment, the upwardly protruding protrusion is in the shape of a half circle. The elongated element 2 is attached along the length of the blade. In the current embodiment, the element extends from a position close to the base of the blade, to a position close to the tip of the blade. One could say that the elongated element is arranged from a position 10% length to a position 90% of the length. However, in other embodiments, the elongated lift mitigating member is attached different amounts along the blade, typically at least along the outer half of the blade. It should be noted that instead of providing one long elongated element, it could be imagined that multiple shorter elongated elements are arranged along the blade, each of said shorter elongated elements being spaced apart from each other. However, the multiple shorter elongated elements can still be considered to be an elongated member extending along the blade, but just not covering the entire length of the blade. The elongated element in this embodiment is attached to the blade while the blade is on the ground prior to lifting the blade up. In the case where the blade is already attached to wind turbine rotor hub, the elongated element could be applied by an operator lowered down along the blade. Other options will also be possible.

The adhesive is of the kind which provides a secure engagement between the blade and the base portion of the elongated element, but also allows the elongated element to be detached from the blade without damaging the blade itself during the removal. The person skilled in the art of adhesives will be able to suggest a suitable adhesive. It is to be noted that the loads on the elongated element will not be significant and as such, the adhesive does not need to be particularly strong.

FIG. 3 shows an alternative embodiment, where instead of an elongated element which is attached to the blade via an adhesive, a round elongated element 12 is arranged adjacent to the blade. This round elongated element could be attached to the blade via point wise attachments arranged offset from each other along the longitudinal axis of the blade, for example via a point wise adhesive applied between the blade and the elongated element. In another embodiment, the elongated element could be attached to the blade via an adhesive applied along the entire length of the round elongated element. In another embodiment, the round elongated element could be attached to the blade via brackets which are individually attached to the blade and spaced apart along the length of the blade. In another embodiment, it could be attached to the blade at only two locations, a first point close to the base of the blade and a second point closer to the tip of the blade. Depending on the curvature of the blade, the actual location of the attachment points can be determined to ensure that the elongated element is arranged closer to the blade surface.

In the above, an example was shown with a half circle and a full circle, however, many other possible shapes are available. In one embodiment, the elongated element has a cross sectional shape of an upside down T. In this case, the base of the T can be arranged adjacent to the surface of the blade. In one embodiment, the two flanges of the T shape could be attached to the blade surface via tape applied to the two flanges of the T shape.

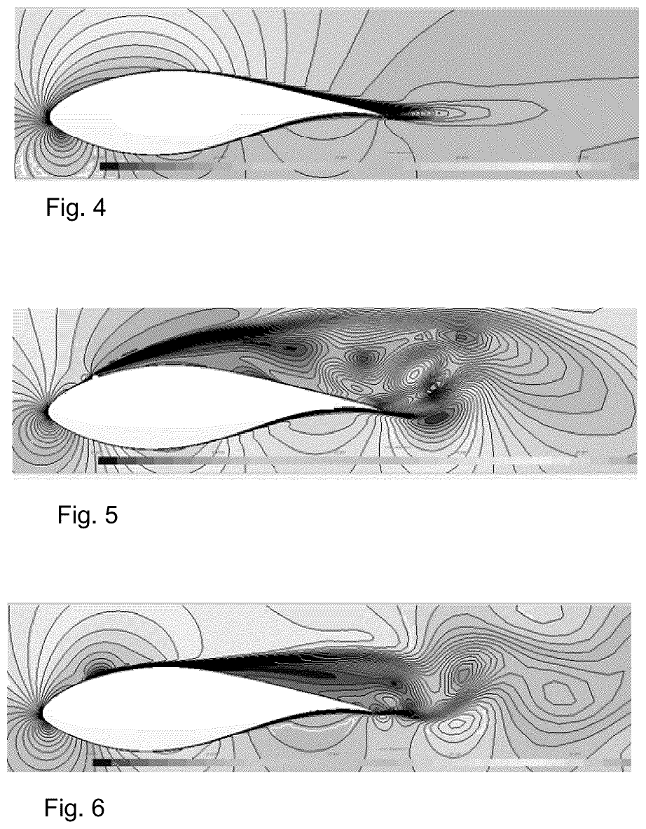

FIG. 4 shows some results of a computational fluid dynamics (CFD) analysis of a blade without any “elongated elements” attached to the blade. As can be seen from the figures, the flow over the suction surface of the blade is clean and is attached to the suction surface of the blade. In this way, the blade will generate lift as is desired for a typical blade. However, during lifting of the blade itself and during mounting of the blade, it will be understood that this lift is not desired as it will result in motion of the blade and/or pendulum motion and/or extra forces which are not desired.

FIG. 5 shows the results of a CFD analysis of the same blade as the blade shown in FIG. 4, but now with an elongated element as shown in FIGS. 1 and 2 attached near the leading edge of the blade. As can be seen, the flow over the suction surface is now very disturbed and is no longer attached to the suction surface of the blade. In this way, the lift produced by the blade, and hence the motion of the blade is significantly reduced. In the actual CFD analysis with a cross section of a real blade with a chord length of 1 m and an angle of attack of 10 degrees, the base line lift coefficient was around 1.59 while in a situation with an elongated element with a cross section in the form of a half circle with a radius of 10 mm, the coefficient of lift was around 0.75. This is a reduction in lift of around 53%. The blade will now be able to be lifted in higher winds with the same blade yoke than before the elongated element was provided or a smaller blade yoke can be used in the same winds.

FIG. 6 also shows the results of a CFD analysis of the same blade as in FIGS. 4 and 5, but in this case, the elongated element of FIG. 3 is attached to the blade. Again, as with the results of the analysis shown in FIG. 5, the flow again becomes turbulent over the suction surface and detaches from the suction surface. Again the lift is reduced and the blade can be lifted in higher winds. In the actual CFD analysis with a cross section of a real blade with a chord line of 1 m and an angle of attack of 10 degrees, the base line lift coefficient was around 1.59 while in a situation with an elongated element having a cross section in the form of a full circle with a radius of 5 mm, the coefficient of lift was around 1.01. This is a reduction in lift of around 37%. Again, with such an elongated member attached to the blade, the blade will now be able to be lifted in higher winds or with a smaller lifting yoke than before the elongated element was provided.

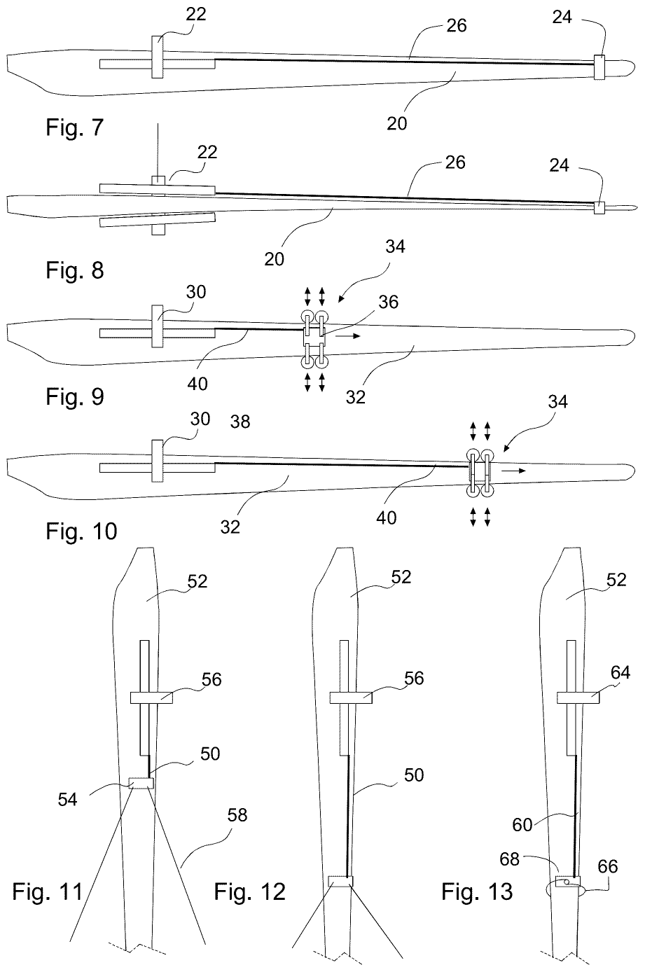

FIGS. 7 and 8 show one approach of connecting an elongated element to a blade to provide the lift mitigating effect described above where it is difficult to attach an elongated element via an adhesive. This would correspond to a situation like the one shown in FIG. 3. In this case, the blade 20 is being lifted by a crane (not shown) via a blade yoke 22. A blade tip clamp 24 is attached near the tip of the blade and a rope 26 is arranged between the blade yoke and the blade tip clamp. This type of arrangement could be connected to the blade while the blade is on the ground, or it could be connected to the blade while the blade is attached to the rotor hub. Some different examples of methods of attaching an elongated element to the blade via a blade yoke and a blade tip clamp are described below.

One method of attaching an elongated element as shown in FIGS. 7 and 8 to a blade is described with reference to FIGS. 9 and 10. In this case, a blade yoke 30 is attached to the blade 32 and a blade tip clamp 34 is provided supported by the blade yoke. The blade tip clamp is provided with a drive mechanism 36 which comprises wheels 38 which are supported on the blade itself. When the blade yoke is attached to the blade. the drive mechanism of the blade tip clamp is also attached to the blade at a location close to the blade yoke. The drive mechanism then “drives” the blade tip clamp out along the blade pulling a rope 40 along. When the blade tip clamp is in a position near the tip of the blade, the blade tip clamp engages the blade more securely and the rope is tightened. In this way, an elongated element is provided which has a lift mitigating effect on the blade. When the lifting operation is finished, the blade tip clamp can “drive” back along the blade until it reaches the blade yoke.

In one embodiment (not shown) a blade tip clamp similar to the one schematically illustrated in FIGS. 9 and 10 is provided with a pressure applying mechanism which can apply a pressure to the elongated element, for example a rope, as the blade tip clamp is being driven out along the blade. In this way, the blade tip clamp could press the rope against the blade and an adhesive applied to the “rope” could engage the rope to the blade surface. In such an example, instead of a blade tip clamp which engages with the blade tip itself, a pressure applying robot could be provided which drives along the blade to press the elongated element against the blade surface as it drives along the blade, thereby attaching an elongated element to the blade surface.

It should be noted that a blade tip clamp having a drive mechanism which can displaceably connect the blade tip clamp to the blade such that the blade tip clamp can move along the blade from a position closer to the root of the blade to a position closer to the tip of the blade could form the basis of a separate divisional application.

Likewise, the provision of a pressure applying robot which is configured to drive from a base portion of the blade along the blade towards the tip of the blade while pressing an elongated element against the blade surface could for the basis of a separate divisional application. In one embodiment of such a pressure applying robot, a method could be provided where the rotor hub is rotated to place the blade in a horizontal position and then the blade is rotated such that the chord of the blade is arranged essentially horizontal. A pressure applying robot could then be driven along the surface of the blade while pressing an elongated member onto the blade surface. In one embodiment, for blades having a very curved surface, the method could comprise the step of actively rotating the blade about its longitudinal axis while the robot is driving along the blade to ensure that the robot can be essentially horizontal at all times while driving. In this way, the robot will not slide off the blade.

In FIGS. 11 and 12, another method of applying a rope 50 to the blade 52, for the purpose of blade lift mitigation, is provided. In this case, the blade is arranged in a vertical position and a blade tip clamp 54 is lowered down from the blade yoke 56 via a rope 50. Tag lines 58 connected to the blade tip clamp extend to the ground and operators and/or automatic winches connected to the tag lines control the position of the blade tip clamp with respect to the blade. When the blade tip clamp is in the desired position, a clamping mechanism on the blade is engaged and the blade tip clamp is engaged with the blade. The rope 50 between the blade yoke and the blade tip clamp is then tightened to provide the lift mitigation effect as described above.

FIG. 13 shows another embodiment of an arrangement to attach a rope 60 to a blade 62 to provide a blade lift mitigation effect as discussed above. In this embodiment a blade yoke 64 is attached to a blade oriented in a downwards position and a weighted belt 66 is lowered from the blade yoke via a rope 60. The weighted belt is arranged wrapped around the blade. When the rope has been extended the desired amount, the weighted belt is tightened via a belt tightening mechanism 68 to fasten the belt to the blade at the specified position. When the belt is tightened, the rope is held in position on the blade.

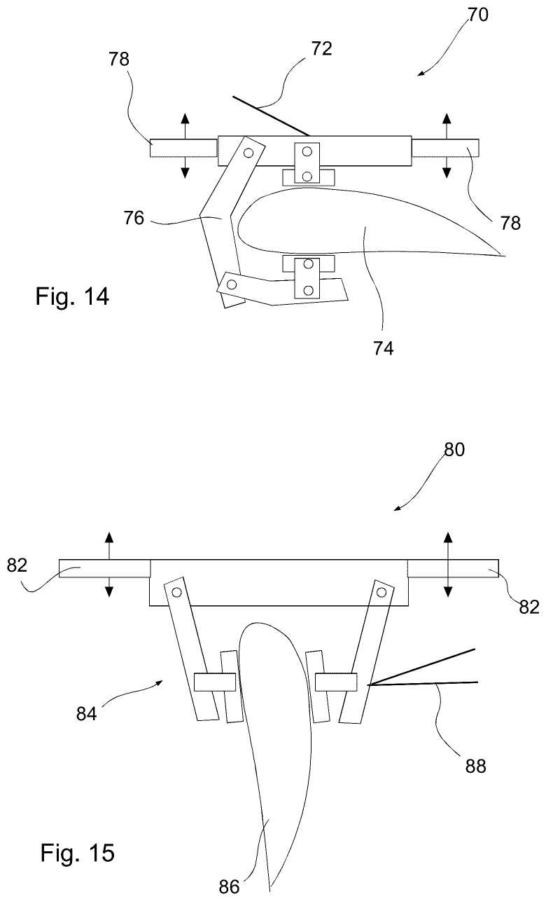

FIG. 14 shows an embodiment of a blade tip clamp 70 which can be used to “fly” a rope 72 from the blade yoke (not shown, but similar to the arrangement in FIG. 8) to the tip of the blade 74. In this embodiment, the blade tip clamp comprises a clamping mechanism 76 which is suitable for clamping onto the blade in a secure manner. The blade tip clamp also comprises four controllable lift generating devices 78, for example four independently controllable variable pitch propellers as known in the art of drones. The blade tip clamp 70 of this embodiment could be arranged on the blade yoke and the rope could be attached to the blade tip clamp and the blade yoke via a winch mechanism. Once the blade yoke is in place, then the blade tip clamp can be flown out to the tip of the blade, pulling the rope along as it moves outwardly. When the blade tip clamp is in the correct position, then the blade tip clamp can clamp onto the blade and the rope tightened. The rope is then in position to provide the blade lift mitigation effect as described above.

It should be noted that the blade tip clamp 70 of FIG. 14 could be used in other applications where something is to be attached to the tip of a blade. For example one or more taglines. Hence, this could be the subject for a divisional application and is described above as an independent “third” invention as described previously in this specification.

An additional example of a blade tip clamp 80 with controllable lift generating devices 82 and a clamp mechanism 84 is shown in FIG. 15. In this example, the blade tip clamp is attached to a blade 86 and two tag lines 88 are attached to the blade tip clamp. In this case, the blade tip clamp could be located on the ground. An operator connects the ends of two tag lines to the blade tip clamp. The blade tip clamp is then flown to the blade and attached to the blade. The taglines are now securely connected to the blade. When it is desired to remove the tag lines from the blade, the clamp mechanism of the blade tip clamp is disengaged from the blade and the blade tip clamp is flown back to the ground.

Note, all embodiments shown in the figures provide lift mitigation except the one shown in FIG. 15. However, the embodiments shown in FIGS. 9-14 also show some different methods of attaching a tip clamp to a blade tip. These methods are novel and are currently claimed with an elongated member which provides a blade lift mitigation effect. However these methods could also form the basis of one or more divisional applications directed to a method of attaching a blade tip clamp to a blade. In these situations, the solution would not necessarily provide a blade lift mitigation effect, but is instead used to attach a tip clamp to the blade.

It is to be noted that the figures and the above description have shown the example embodiments in a simple and schematic manner. Many of the specific mechanical details have not been shown since the person skilled in the art should be familiar with these details and they would just unnecessarily complicate this description. For example, the specific materials used and the specific manufacturing procedures have not been described in detail since it is maintained that the person skilled in the art would be able to find suitable materials and suitable processes to implement the method and devices according to the current invention.

1. Method of lifting a wind turbine blade, characterized in that said method comprises the step of
a. providing a wind turbine blade,
b. providing a blade yoke and connecting the blade yoke to the wind turbine blade,
c. providing an elongated element connected to the wind turbine blade adjacent to the suction or pressure surface, the elongated element:
i. being arranged along at least 50% of the outer ⅓ of the wind turbine blade,
ii. being arranged along the longitudinal axis of the wind turbine blade, and
iii. the elongated element being arranged to reduce the coefficient of lift of the wind turbine blade by more than 20%, and
d. lifting the wind turbine blade via the blade yoke.

2. Method according to claim 1, characterized in that the method comprises the steps of:
a. calculating the maximum estimated lift generated by the wind turbine blade with the elongated member connected to the wind turbine blade due to the maximum expected wind speed, and
b. sizing the blade yoke according to the maximum estimated lift generated by the wind turbine blade with the elongated member connected to the wind turbine blade.

3. Method according to claim 1, characterized in that the method further comprises the steps of attaching one end of the elongated element to the blade yoke, providing an attachment member, attaching the attachment member to the wind turbine blade at a location near the tip of the wind turbine blade and attaching another end of the elongated element to the attachment member.

4. Method according to claim 3, characterized
a. in that said step of providing an attachment member comprises providing a blade tip clamp,
b. in that said step of attaching another end of the elongated member to the attachment member comprises attaching the other end of the elongated member to the blade tip clamp, and
c. in that said method further comprises the steps of:
i. rotating the rotor hub until the wind turbine blade to which the blade tip clamp is to be attached is in a downwardly extending orientation,
ii. lowering the blade tip clamp along the wind turbine blade from the blade yoke via the elongated member, and
iii. controlling the position of the blade tip clamp relative to the blade via taglines attached to the blade tip clamp, and
d. in that said step of attaching the attachment member to the wind turbine blade at a location near the tip of the wind turbine blade comprises attaching the blade tip yoke to the wind turbine blade near the tip of the wind turbine blade.

5. Method according to claim 3, characterized
a. in that said step of providing an attachment member includes providing a blade tip clamp having one or more controllable lift generating devices,
b. in that said step of attaching another end of the elongated member to the attachment member includes attaching the other end of the elongated member to the blade tip clamp,
c. in that said method further comprises the step of flying the blade tip clamp via the one or more controllable lift generating devices to a position on the wind turbine blade located remotely from the blade yoke, and
d. in that said step of attaching the attachment member to the wind turbine blade at a location near the tip of the wind turbine blade comprises attaching the blade tip yoke to the wind turbine blade at a location near the tip of the wind turbine blade.

6. A method, comprising: using an elongated member connected to a wind turbine blade and arranged along a longitudinal axis of the wind turbine blade to reduce the maximum generated lift of the wind turbine blade due to wind when lifting the wind turbine blade.

7. A method, comprising: using an elongated member according to claim 6, characterized in that the elongated member is connected to the wind turbine blade via a blade yoke attached to the wind turbine blade and a blade tip clamp attached to the wind turbine blade near the tip of the wind turbine blade.

8. Wind turbine blade having a longitudinal axis, a suction surface and a pressure surface, characterized in that the wind turbine blade further comprises an elongated element, said elongated element:
a. being connected to the wind turbine blade and arranged adjacent to the suction or the pressure surface of the wind turbine blade,
b. being arranged along at least 50% of the outer ⅓^{rd} of the wind turbine blade,
c. extending along the longitudinal axis of the wind turbine blade, and
d. being arranged to reduce the coefficient of lift of the wind turbine blade by more than 20%.

9. Wind turbine blade according to claim 8, characterized in that the elongated element is arranged such that the distance between the local centre of the elongated element and the leading edge of the wind turbine blade is less than 50% of the local chord length of the wind turbine blade.

10. Wind turbine blade according to claim 8, characterized in that the elongated element is attached to the pressure or the suction surface of the wind turbine blade via an adhesive.

11. Wind turbine blade according to claim 8, characterized in that the elongated element is not attached to the suction surface of the wind turbine blade via an adhesive.

12. Wind turbine blade lifting system comprising a wind turbine blade according to claim 8, characterized in that the system further comprises a blade yoke attached to the wind turbine blade near the centre of gravity of the wind turbine blade, a blade tip clamp attached to the wind turbine blade near the tip of the wind turbine blade and in that the elongated element is arranged between the blade yoke and the blade tip clamp.
